(19) United States
(12) Patent Application Publication
(10) Pub. No.: US 2008/0189109 A1
(43) Pub. Date: Aug. 7, 2008

(54) Segmentation posterior based boundary point determination

(75) Inventors: Yu Shi, Beijing (CN); Frank Kao-Ping Soong, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/702,373

(22) Filed: Feb. 5, 2007

(51) Int. Cl. G10L 15/00

(52) U.S. Cl. 704/240

(57) ABSTRACT

Boundary points for speech in an audio signal are determined based on posterior probabilities for the boundary points given a set of possible segmentations of the audio signal. The boundary point posterior probability is determined based on a set of level posterior probabilities that each provide the probability of a sequence of feature vectors given one of the segmentations in the set of possible segmentations.

### BACKGROUND

Speech recognition is hampered by background noise present in the input signal. To reduce the effects of background noise, efforts have been made to determine when an input signal contains noisy speech and when it contains just noise. For segments that contain only noise, speech recognition is not performed and as a result recognition accuracy improves since the recognizer does not attempt to provide output words based on background noise. Identifying portions of a signal that contain speech is known as voice activity detection (VAD) and involves finding the starting point and the ending point of speech in the audio signal.

The discussion above is merely provided for general background information and is not intended to be used as an aid in determining the scope of the claimed subject matter.

### SUMMARY

Boundary points for speech in an audio signal are determined based on posterior probabilities for the boundary points given a set of possible segmentations of the audio signal. The boundary point posterior probability is determined based on a set of level posterior probabilities that each provide the probability of a sequence of feature vectors given one of the segmentations in the set of possible segmentations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of elements used in finding speech endpoints under one embodiment.

FIG. 2 is a flow diagram of auto segmentation under one embodiment.

FIG. 3 is a graph of segment boundaries for various levels of segmentation for a clean speech signal.

FIG. 4 is a graph of segment boundaries for various levels of segmentation for a noisy speech signal.

FIG. 5 is a flow diagram for computing boundary point posterior probabilities to selecting speech start and end points.

FIG. 6 is a block diagram of one computing environment in which some embodiments may be practiced.

### DETAILED DESCRIPTION

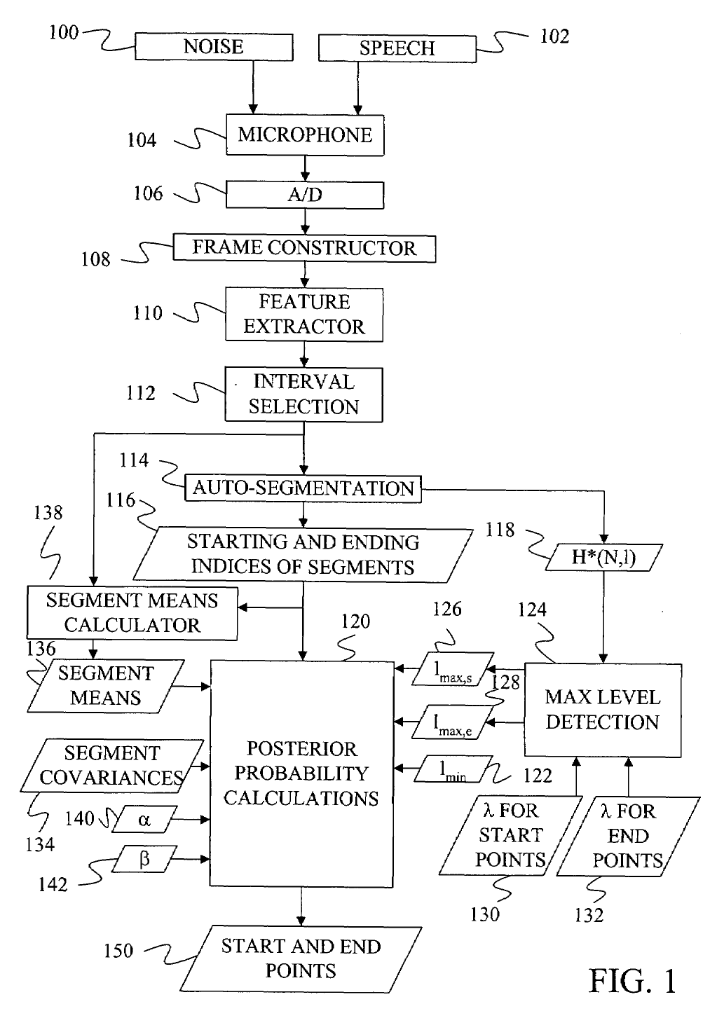

Embodiments described in this application provide techniques for identifying starting points and ending points of speech in an audio signal using a posterior probability. As shown in FIG. 1, noise 100 and speech 102 are detected by a microphone 104. Microphone 104 converts the audio signals of noise 100 and speech 102 into an electrical analog signal. The electrical analog signal is converted into a series of digital values by an analog-to-digital (A/D) converter 106. In one embodiment, A/D converter 106 samples the analog signal at 16 kilohertz with 16 bits per sample, thereby creating 32 kilobytes of data per second. The digital data provided by A/D converter 106 is input to a frame constructor 108, which groups the digital samples into frames with a new frame every 10 milliseconds that includes 25 milliseconds worth of data.

A feature extractor 110 uses the frames of data to construct a series of feature vectors, one for each frame. Examples of features that can be extracted include variance normalized time domain log energy, Mel-frequency Cepstral Coefficients (MFCC), log scale filter bank energies (FBanks), local Root Mean Squared measurement (RMS), cross correlation corresponding to pitch (CCP) and combinations of those features.

The feature vectors identified by feature extractor 110 are provided to an interval selection unit 112. Interval selection unit 112 groups contiguous frames into intervals. Under one embodiment, each interval contains frames that span 0.5 seconds of the input audio signal.

The features for the frames of each interval are provided to an auto-segmentation unit 114, which divides each interval into segments. The segments contain sets of frames defined by consecutive indices such that the segments do not overlap, there are no spaces between segments, and the segments taken together cover the entire interval.

Under one embodiment, auto-segmentation unit 114 performs a multi-level search for possible segmentations of the interval. At each level, l, of the search, the interval is divided into l segments. Thus, at level one of the search, the interval is in one segment. At level two of the search, the interval is divided into two segments, and so on up to a level L. The multi-level search is defined mathematically as:

$${H}^{*} ( n , l ) = {min}_{l - 1 \leq j < n} \{ {H}^{*} ( j , l - 1 ) + D ( j + 1 , n ) \} \qquad EQ . 1$$

where H*(j,l−1)is a distortion measure for an optimal segmentation up to frame n on level l, j+1 is the index of the beginning frame of the last segment on level l, n is the ending frame of the last segment on level l, H*(j,l−1) is set using equation 1 on a previous level and D(j+1,n) is a within segment distortion measure of feature vectors from frame j+1 to frame n, which under one embodiment is defined as:

$$\begin{matrix}D ( {n}_{1} , {n}_{2} ) = {\sum }_{n = {n}_{1}}^{{n}_{2}} {[ {\vec{x}}_{n} - \vec{C} ( {n}_{1} , {n}_{2} ) ]}^{T} [ {\vec{x}}_{n} - \vec{C} ( {n}_{1} , {n}_{2} ) ] & EQ . 2 \\ \vec{C} ( {n}_{1} , {n}_{2} ) = \frac{1}{{n}_{2} - {n}_{1} + 1} {\sum }_{n = {n}_{1}}^{{n}_{2}} {\vec{x}}_{n} & EQ . 3\end{matrix}$$

where n₁ is an index for the first frame of the segment, n₂ is an index for the last frame of the segment, \vec{x}ₙ is a feature vector for the nth frame, superscript T represents the transpose and \vec{C}(n₁,n₂) represents a centroid for the segment. Although the distortion measure of EQs. 2 and 3 is discussed herein, those skilled in the art will recognize that other distortion measures or likelihood measures may be used.

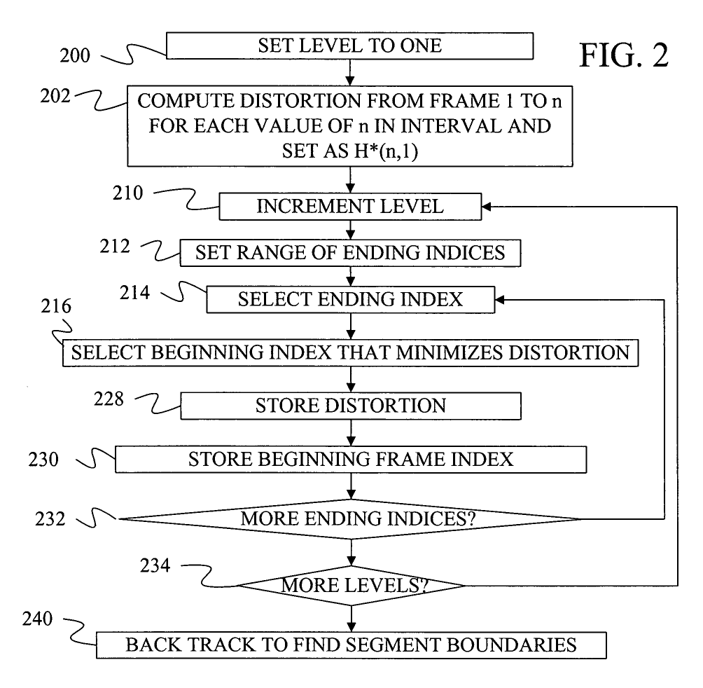

FIG. 2 provides a flow diagram of an auto-segmentation method under one embodiment.

In step 200, the level of the search is set to one. At step 202, for each frame, n, in the interval, a within segment distortion measure is determined from the first frame to frame n using EQs. 2 and 3 above. The calculated within segment distortion is then set as H*(n,1) for each frame n for level one.

At step 210, the level is incremented by one. At step 212, the range of ending indices n, is set for the segment associated with the new level. The lower boundary for the ending index is set equal to the current level l and the upper boundary for the ending index is set equal to the total number of frames in the interval, N.

At step 214, an ending index n that is within the range set in step 212 is selected. At step 216, equation 1 is used to find the beginning frame index for a segment that ends at ending index n and that results in a minimum distortion across the entire segmentation up to index n. Under some embodiments, this involves using equation 1 to calculate a distortion for each possible beginning frame, j+1, and then selecting the beginning frame that produces the minimum distortion.

During the computation of the distortion in equation 1, j, which is one less than the beginning frame of the last segment, and the previous level, l−1, are used as indices to retrieve a stored distortion H*(j,l−1) for the previous level, l−1. The retrieved distortion value is added to the distortion computed for the last segment to produce the distortion that is associated with the beginning frame of the last segment.

The minimum distortion that is formed from the selected beginning index, H*(n,l), is stored at step 228 such that it can be indexed by the level or number of segments l and the index of the last frame, n.

At step 230, the beginning frame index j in EQ. 1 that result in the minimum for H*(n,l) is stored as p(n,l) such that index j is indexed by the level or number of segments l and the ending frame n.

At step 232, the process determines if there are more ending frames for the current level of dynamic processing. If there are more ending frames, the process returns to step 214 where n is incremented by one to select a new ending index. Steps 216, 228, 230 and 232 are then performed for the new ending index.

When there are no more ending frames to process, the method determines if there are more levels of segmentation at step 234. If there are more levels at step 234, the level is incremented at step 210 and steps 212 through 234 are repeated for the new level.

When there are no more levels of segmentation, the process continues at step 240 where it backtracks through each segmentation at each level that ends at the last frame of the interval using the stored values p(n,l). For example, p(N,l) contains the value, j, of the ending index for the segment preceding the last segment in the optimal segmentation for level l. This ending index is then used to find p(j,l−1), which provides the ending index for the next preceding segment. Using this backtracking technique, the starting and ending index of each segment in the optimal segmentation of each level can be retrieved.

The process of FIG. 2 performed by auto-segmentation unit 114 of FIG. 1 results in starting and ending indices 116 for each segment at each level as well as a minimum distortion measure H*(N,l) 118 for the last frame N of each level. The starting and ending indices 116 represent boundaries between segments in a segmentation.

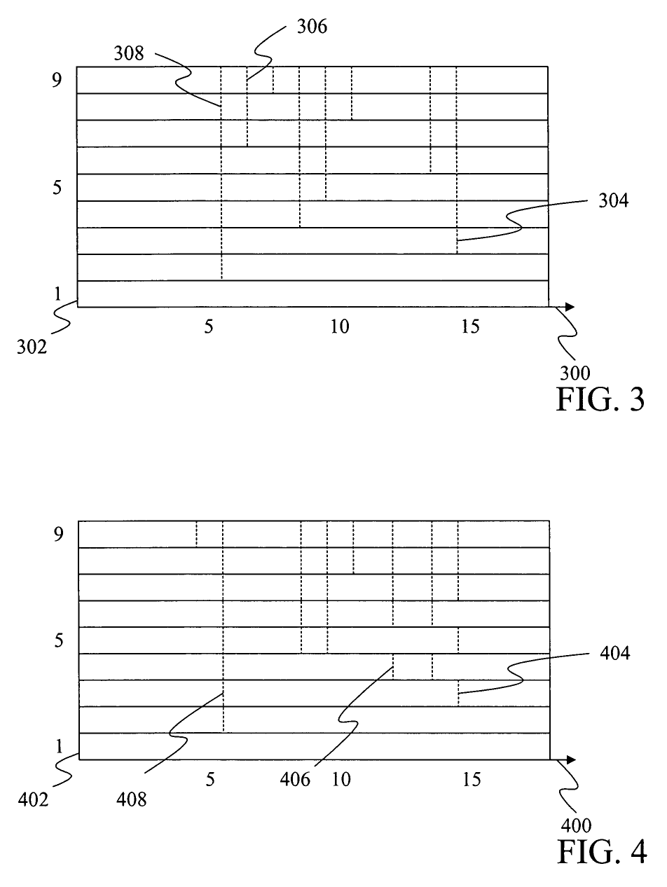

FIGS. 3 and 4 provide an example of segment boundaries identified for each of a set of levels for a speech signal recorded in a relatively noise-free environment and in a noisy environment, respectively, using the method of FIG. 2. In FIGS. 3 and 4, frame counts are shown along the horizontal axes 300 and 400, respectively, and segmentation levels are shown along the vertical axes 302 and 402, respectively. Segment boundaries are shown as vertical lines across the levels and occur between the ending index of one segment and the starting index of the next segment as identified in starting and ending indices 116 examples of segment boundaries include segment boundaries 304, 306 and 308 of FIG. 3 and segment boundaries 404, 406 and 408 of FIG. 4.

As shown in FIG. 3, the segment boundaries identified at each level for a relatively clean speech signal are consistent such that a segment boundary identified at a lower segmentation level is also identified at all of the segmentation levels above that lower level. For example, segment boundary 308 is identified for levels 2 through 9. However, as shown in FIG. 4, when the speech signal is obscured by noise, the segment boundaries become inconsistent between levels. For example, segment boundary 404 is found at levels 3, 5, and 7-9 but is missing at levels 4 and 6.

During voice activity detection, it is assumed that the interval begins and ends without speech. Thus, the goal is to find the segment boundary at the end of the first segment, which represents the starting point of speech in the interval, and the beginning of the last segment in the interval, which represents the ending point of speech in the interval. As shown in FIGS. 3 and 4, different levels will identify different ending boundaries for the first segment and different starting boundaries for the last segment, especially if noise is present in the input signal.

To determine which of the segment boundaries identified in the various levels should be selected as a speech boundary point, embodiments described herein calculate a posterior probability for each possible speech starting point and each possible speech ending point identified in any of the segmentation levels. Each posterior probability is calculated by summing over posterior probabilities for levels that include the possible speech starting point (or possible speech ending point) within a range of levels. In terms of equations, the posterior probabilities are calculated as:

$$\begin{matrix}P ( {n}_{start point} \text{\textbar} {X}_{1}^{N} ) = \frac{{\sum }_{{l = {l}_{min}}_{if {n}_{l .1} \approx {n}_{start point}}}^{{l}_{max , s}} {P ( {X}_{1}^{N} \text{\textbar} l )}^{α}}{{\sum }_{l = {l}_{min}}^{{l}_{max , s}} {P ( {X}_{1}^{N} \text{\textbar} l )}^{α}} & Eq . 4 \\ P ( {n}_{end point} \text{\textbar} {X}_{1}^{N} ) = \frac{{\sum }_{{l = {l}_{min}}_{if {n}_{l , l - 1} + 1 \approx {n}_{end point}}}^{{l}_{max , e}} {P ( {X}_{1}^{N} \text{\textbar} l )}^{β}}{{\sum }_{l = {l}_{min}}^{{l}_{max , e}} {P ( {X}_{1}^{N} \text{\textbar} l )}^{β}} & Eq . 5\end{matrix}$$

where P(n_{start point}|Xₗ^{N}) is the boundary point posterior probability for a possible speech starting point n_{start point} in the interval given the set of feature vectors Xₗ^{N} from frame 1 to frame N of the interval, P(n_{end point}|Xₗ^{N}) is the boundary point posterior probability for a possible speech ending point n_{end point} in the interval given the set of feature vectors Xₗ^{N} from frame 1 to frame N of the interval, α is an exponential weight that is trained on a training set so that a true speech starting point in the training set provides the maximum posterior probability, β is an exponential weight that is trained on a training set so that a true speech ending point in the training set provides the maximum posterior probability, P(Xₗ^{N}|l) is the segmentation posterior probability for each level, and the range of levels over which the summations are taken are set by maximum levels l_{max,s} and l_{max,e} and minimum level lₘᵢₙ.

The segmentation posterior probability P(Xₗ^{N}|l) for each level in Equations 4 and 5 is calculated as:

$$P ( {X}_{1}^{N} \text{\textbar} l ) = {\prod }_{k = 1}^{l} P ( {X}_{{n}_{l , k - 1} + 1}^{{n}_{t , k}} \text{\textbar} l , k ) \qquad Eq . 6$$

where k is a segment, n_{l,k} is the last frame of segment k, and n_{l,k-1}+1 is the first frame of segment k, with the posterior probability for a segment calculated as:

$$P ( {X}_{{n}_{l , k - 1} + 1}^{{n}_{l , k}} \text{\textbar} l , k ) = {\prod }_{n = {n}_{l , k - 1} + 1}^{{n}_{l , k}} P ( {\vec{x}}_{n} \text{\textbar} l , k ) \qquad Eq . 7$$

where P(\vec{x}ₙ|l,k) is the probability of feature vector \vec{x}ₙ given level l and segment k and under one embodiment is computed as:

P(\vec{x}ₙ|l,k)=N(\vec{x}ₙ;\vec{μ}_{l,k},Σ_{l,k}) Eq. 8

where N(\vec{x}ₙ;\vec{μ}_{l,k},Σ_{l,k}) denotes a normal distribution with mean \vec{μ}_{l,k} and covariance matrix \vec{Σ}_{l,k}. Under one embodiment, the covariance matrix is the identity matrix and the mean is computed as:

$${\vec{μ}}_{l , k} = \frac{{\sum }_{n = {n}_{l , k - 1} + 1}^{{n}_{l , k}} {\vec{x}}_{n}}{{n}_{l , k} - {n}_{l , k - 1}} \qquad Eq . 9$$

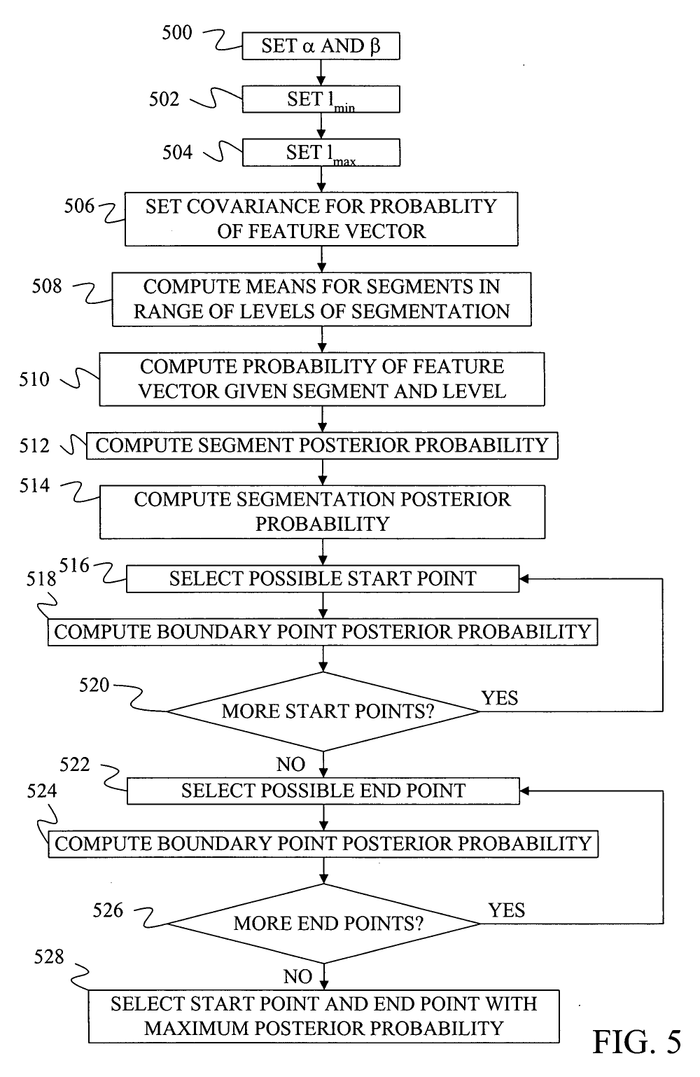

FIG. 5 provides a flow diagram of a method for computing the boundary point posterior probabilities for the possible starting points and the possible ending points. In step 500, values for exponential weight α 140 for calculating starting point posterior probabilities and exponential weight β 142 for calculating ending point posterior probabilities are set. Under one embodiment, α=0.006 and β=0.0002.

At step 502, a minimum segmentation level lₘᵢₙ 122 that defines the lower limit of the range of segmentation levels used in EQs. 4 and 5 is selected. Under one embodiment, this lower limit is set to 3.

At step 504, a maximum level detection unit 124 computes two different maximum levels 126 and 128. Maximum level 126, l_{max,s}, is used in EQ. 4 to compute starting point posterior probabilities. Maximum level 128, l_{max,e}, is used in EQ. 5 to compute ending point posterior probabilities.

Under one embodiment, the maximum levels are set by identifying the level at which a penalized homogeneity score is minimized such that:

$${l}_{max} = {\text{arg} min}_{1 \leq l \leq L} F ( N , l ) \qquad Eq . 10$$

with

F(N,l)=H*(N,l)+λP(N,l) Eq. 11

where H*(N,l) is the minimum distortion measure determined by auto-segmentation unit 114 using Equation 1 above for the last frame N of level l, λ is a penalty weight and P(N,l) is a penalty that under one embodiment is calculated as:

P(N,l)=l*d log(N) EQ. 12

where d is the number of dimensions in the feature vector.

To compute maximum level 126 for the starting point, maximum level detection unit 124 uses a penalty weight λ 130 that is computed specifically for starting points. Under one embodiment, starting point penalty weight 130 is chosen to minimize the mean square error of the estimated maximum level, lₘₐₓ, over a training set as:

$${λ}^{*} = {\text{arg} min}_{λ} {\sum }_{i ∈ training set} {( {l}_{max} ( i ) - {l}_{i} )}^{2} \qquad Eq . 13$$

where lₘₐₓ(i) is the value of lₘₐₓ computed using EQs. 10-12 above based on λ and the ith interval in the training set, and lᵢ is the maximum level that had the correct starting point in the ith interval. Under one embodiment, λ=0.32 for determining the value of lₘₐₓ for starting points.

To compute maximum level 128 for the ending point, maximum level detection unit 124 uses a penalty weight λ 132 that is computed specifically for ending points. Under one embodiment, ending point penalty weight 132 is chosen to minimize the mean square error of the estimated maximum level, lₘₐₓ, over a training set as:

$${λ}^{*} = {\text{arg} min}_{λ} {\sum }_{i ∈ training set} {( {l}_{max} ( i ) - {l}_{i} )}^{2} \qquad Eq . 14$$

where lₘₐₓ(i) is the value of lₘₐₓ computed using EQs. 10-12 above based on λ and the ith interval in the training set, and lᵢ is the maximum level that had the correct ending point in the ith interval. Under one embodiment, λ=0.1105 for determining the value of lₘₐₓ for ending points.

At step 506, a covariance matrix Σ_{l,k} 134 for each segment k in each level l is set. In the embodiment of FIG. 1, the covariance matrix is the same for each segment and level. At step 508, mean feature vectors 136, \vec{μ}_{l,k}, are computed for each segment in each level between minimum level 122 and the larger of maximum level 126 and maximum level 128 by a segment means calculator 138 using EQ. 9 above.

At step 510, the means 134 and covariances 136 are used in EQ. 8 by posterior probability calculations unit 120 to compute a probability for each feature vector given a segment and a level of segmentation. A separate feature vector probability is computed for each segment in each level in the range of segmentation levels between minimum level 122 and the larger of maximum level 126 and maximum level 128.

At step 512, posterior probability calculations unit 120 uses the probabilities of the feature vectors given the segments and levels to compute a segment posterior probability using EQ. 7 above. Under one embodiment, a separate segment posterior probability is computed for each segment in each segmentation level in the range between level minimum 122 and the larger of level maximum 126 and level maximum 128.

At step 514, posterior probability calculations unit 120 computes a level posterior probability using the segment posterior probabilities and EQ. 6 above. Under one embodiment, a separate level posterior probability is computed for each level of segmentation in the range between level minimum 122 and the larger of level maximum 126 and level maximum 128.

At step 516, a possible starting point of speech as identified in one of the levels of segmentation is selected. At step 518, posterior probability calculations unit 120 uses EQ. 4 above with the level posterior probabilities to compute a boundary point posterior probability for the selected starting point. At step 520, posterior probability calculations unit 120 determines if there are more possible starting points for speech that were identified in the levels of segmentation. If there are more possible starting points, the next starting point is selected by returning to step 516 and a boundary point posterior probability is calculated for the new starting point at step 518. Steps 516-520 are repeated until a boundary point posterior probability has been computed for each starting point identified in the levels of segmentation.

At step 522, a possible ending point of speech as identified in one of the levels of segmentation is selected. At step 524, posterior probability calculations unit 120 uses EQ. 5 above with the level posterior probabilities to compute a boundary point posterior probability for the selected ending point. At step 526, posterior probability calculations unit 120 determines if there are more possible ending points for speech that were identified in the levels of segmentation. If there are more possible ending points, the next ending point is selected by returning to step 522 and a boundary point posterior probability is calculated for the new ending point at step 524. Steps 522-526 are repeated until a boundary point posterior probability has been computed for each ending point identified in the levels of segmentation.

At step 528, posterior probability calculations unit 120 selects the starting point and the ending point with the highest boundary point posterior probabilities as starting and ending points 150 for the interval.

In the discussion above, the posterior probabilities for possible boundary points were calculated based on multiple levels of segmentation of an audio signal. In other embodiments, speech and noise models may be used to generate multiple hypotheses of what frames of an audio signal contain speech and what frames do not contain speech. Each hypothesis has an associated probability that can be considered a segmentation probability. In such embodiments, the starting point posterior probabilities P(n_{start point}|Xₗ^{N}) may be calculated by summing over the segmentation probabilities for the hypotheses that show speech beginning at a particular starting point and dividing the sum by the sum of the probabilities for all hypotheses. Similarly, the ending point posterior probabilities P(n_{end point}|Xₗ^{N}) may be calculated by summing over the segmentation probabilities for the hypotheses that show speech ending at a particular ending point and dividing the sum by the sum of the probabilities for all hypotheses.

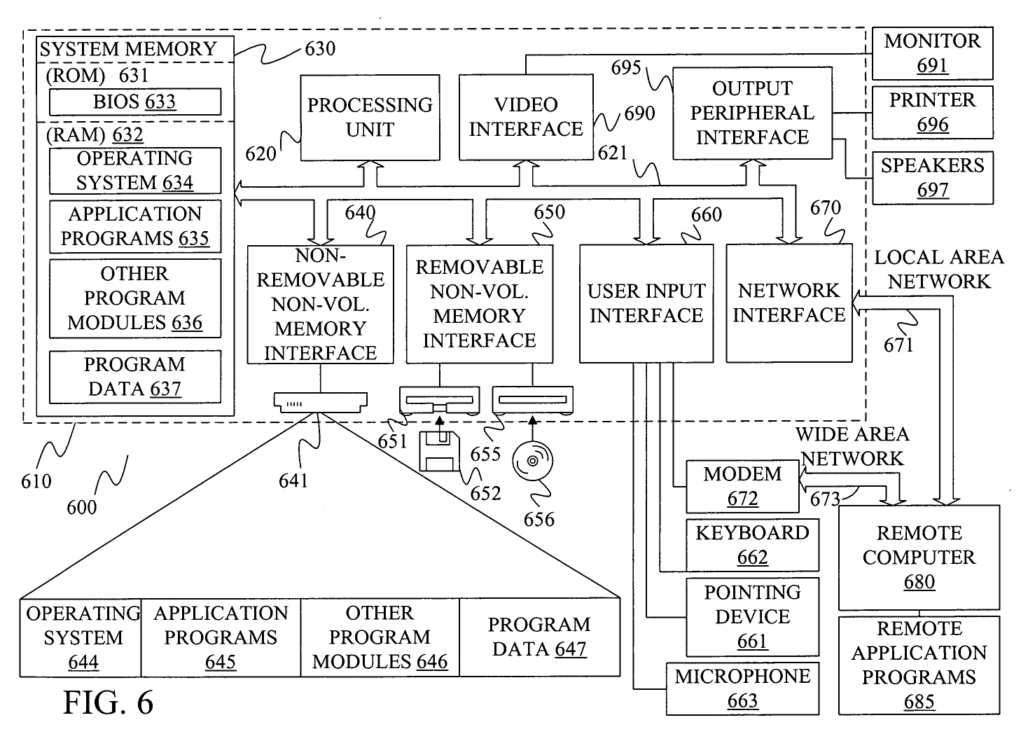

FIG. 6 illustrates an example of a suitable computing system environment 600 on which embodiments may be implemented. The computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary operating environment 600.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 6, an exemplary system for implementing some embodiments includes a general-purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies.

A user may enter commands and information into the computer 610 through input devices such as a keyboard 662, a microphone 663, and a pointing device 661, such as a mouse, trackball or touch pad. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on remote computer 680. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
performing multiple segmentations of a sequence of feature vectors that represent an audio signal, each segmentation providing at least one segment boundary that is different from segment boundaries in other segmentations;
determining a separate segmentation probability for each segmentation, each segmentation probability providing the probability of the sequence of feature vectors given the segmentation;
determining a boundary point posterior probability for a possible boundary point of speech by summing over the segmentation probabilities for a set of segmentations that segment the sequence of feature vectors such that the possible boundary point represents a boundary point for speech in the segmentation; and
using the boundary point posterior probability to select a possible boundary point of speech as a boundary point of speech.

2. The method of claim 1 wherein determining a segmentation probability comprises determining a separate segment posterior probability for each segment in the segmentation, each segment posterior probability providing the probability of a sub-sequence of the sequence of feature vectors given the segment that the sub-sequence of feature vectors is segmented into in the segmentation.

3. The method of claim 2 wherein determining a segment posterior probability comprises determining a separate probability for each feature vector in the sub-sequence, wherein determining a probability for a feature vector comprises applying the feature vector to a normal distribution for a segment.

4. The method of claim 3 wherein the normal distribution comprises a mean that is computed from the feature vectors in the segment.

5. The method of claim 1 wherein the set of segmentations comprises levels of segmentation where each level comprises a different number of segments and wherein the number of segments is between a minimum level and a maximum level such that the set of levels contains fewer than all of the levels in which a segmentation was performed.

6. The method of claim 5 further comprising determining the maximum level by identifying a level of segmentation at which a penalized homogeneity score is minimized.

7. The method of claim 6 wherein the penalized homogeneity score comprises a distortion measure and a weighted penalty that is based on the number of segments in the level.

8. The method of claim 7 wherein the weighted penalty is weighted by a weight that is trained on training data to minimize the mean square error of the estimated maximum level.

9. The method of claim 8 wherein determining a boundary point posterior probability for a possible boundary point of speech comprises determining multiple boundary point posterior probabilities for multiple possible boundary points of speech.

10. The method of claim 9 wherein determining multiple boundary point posterior probabilities for multiple possible boundary points of speech comprises determining a boundary point posterior probability for at least one starting boundary point that represents the start of speech and determining a boundary point posterior probability for at least one ending boundary point that represents the end of speech.

11. The method of claim 10 wherein determining a boundary point posterior probability for a starting boundary point and a boundary point posterior probability for an ending boundary point comprises using a different maximum level for the starting boundary point than for the ending boundary point.

12. A computer-readable medium having computer-executable instructions for performing steps comprising:
selecting a boundary point for speech in an audio signal from a plurality of possible boundary points found in a plurality of possible segmentations of the audio signal;
forming a summation of probabilities that is limited to probabilities associated with segmentations in the plurality of possible segmentations in which the selected possible boundary point is positioned as a boundary point;
using the summation of probabilities to determine a probability that the selected possible boundary point is a boundary point for speech; and
using the probability that the selected possible boundary point is a boundary point for speech to set a boundary point for speech in the audio signal.

13. The computer-readable medium of claim 12 wherein each possible segmentation in the plurality of possible segmentations has a different number of segments.

14. The computer-readable medium of claim 12 further comprising determining a maximum number of segments that can be in a segmentation associated with a probability used to form the summation of probabilities based on penalized homogeneity scores for the plurality of segmentations.

15. The computer-readable medium of claim 12 wherein a probability associated with a segmentation is determined based in part on a probability of a feature vector given a segment in the segmentation.

16. The computer-readable medium of claim 15 wherein the probability of a feature vector given a segment is based in part on a mean feature vector for the segment.

17. A method comprising:
determining a maximum number of segments that can be found in segmentations used to determine the probability of a possible boundary point of speech in an audio signal based in part on distortion measures for a plurality of segmentations;
determining probabilities for a plurality of segmentations that have fewer than the maximum number of segments;
using the probabilities for the plurality of segmentations to determine a probability for each of at least two boundary points; and
selecting one of the at least two boundary points as a boundary point of speech in the audio signal based on the probabilities for the at least two boundary points.

18. The method of claim 17 wherein the plurality of segmentations comprise at least one segmentation with more than the maximum number of segments.

19. The method of claim 17 wherein determining a probability for a segmentation comprises determining a probability of a feature vector given a segment in the segmentation.

20. The method of claim 19 wherein the probability of a feature vector given a segment is based in part on a mean feature vector for the segment.
